(19) United States
(12) Patent Application Publication
(10) Pub. No.: US 2010/0198753 A1
(43) Pub. Date: Aug. 5, 2010

(54) METHOD OF STAGING RELIEF SUPPLIES

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,713

(22) PCT Filed: Jul. 24, 2006
(86) PCT No.: PCT/US06/28641

§ 371 Date: Jan. 24, 2008

Related U.S. Application Data
(60) Provisional application No. 60/702,476, filed on Jul. 26, 2005.
(60) Provisional application No. 60/727,136, filed on Oct. 14, 2005.
(60) Provisional application No. 60/785,941, filed on Mar. 24, 2006.

(51) Int. Cl. G06Q 90/00; G09F 13/04; G09F 13/22

(52) U.S. Cl. 705/500; 40/541; 40/544

(57) ABSTRACT

A method of public service includes the steps of providing at least one site for a structure from which emergency relief supplies are staged fo benefitting a populace in an event of disaster and promoting a business by providing that site.

This application claims the benefit of U.S. provisional patent applications Ser. Nos. 60/702,476 filed 26 Jul. 2005, 60/727,136 filed 14 Oct. 2005 and 60/785,941 filed 24 Mar. 2006.

### TECHNICAL FIELD

The present invention relates to the fields of public service and business promotion.

### BACKGROUND OF THE INVENTION

Recent events including, particularly, the catastrophic destruction of New Orleans by Hurricane Katrina have highlighted a need for the establishment of emergency relief provision storage facilities in and around “at risk” population centers. Such facilities will provide a number of advantages including prompt delivery of relief supplies to victims of natural or other disasters while also alleviating some of the logistical problems in supplying tons of relief provisions to a stricken area.

The biggest hurdle to providing onsite or on location storage facilities for relief provisions remains the cost of the building or storage structure. The present invention greatly reduces or eliminates these costs for the governmental agency or relief organization wishing to establish a relief provision storage facility at any particular location.

### SUMMARY OF THE INVENTION

In accordance with the present invention, a method of public service is provided. That method comprises the steps of providing at least one site for a structure from which another entity may stage emergency relief supplies for benefitting a population in an event of disaster and promoting a business by providing the site. In accordance with one aspect of the present invention the method may include operating multiple retail stores and providing multiple sites for structures adjacent those retail stores. In accordance with another aspect of the invention, the method may include operating multiple shopping malls and providing multiple sites for structures adjacent those malls.

Further, the method may include providing advertising on the structures. In one possible embodiment the method includes using at least a portion of the advertising to promote sales at the retail store or mall. Further the method may include marketing at least a portion of the advertising to another entity. Still further the method may include illuminating the advertising. The advertising may be provided on banners and those banners may be back lighted. In another possible embodiment the advertising is provided on banners made from electroluminescent material that is lighted so as to be self-illuminating.

In yet another possible embodiment a video display is used to provide the advertising. The video display may be a plasma monitor, a liquid crystal display, an LED display or the like. In yet another embodiment, the structure includes a rotary sign assembly for displaying the advertising. The method may include allowing either a governmental relief agency or a private relief agency to use the structure. Further the method includes displaying public service information on the structure.

The following is a detailed description of the invention. It should be realized, however, that this is just one possible embodiment of the invention and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention and together with the description serves to explain certain principles of the invention. In the drawing:

FIG. 1 is a perspective view of the integrated advertising and building structure of the present invention; and

FIG. 2 is a schematical end elevational view of the structure of FIG. 1 through the open end doors.

### DETAILED DESCRIPTION OF THE INVENTION

In accordance with the present invention, a method of public service is provided. That method may be broadly defined as including the steps of providing at least one site for a structure from which emergency relief supplies are staged for benefitting a population in the event of disaster and promoting a business by providing that site. In one possible embodiment the method includes operating multiple retail stores and providing multiple sites for structures adjacent those retail stores. In another possible embodiment the method includes operating multiple shopping malls and providing multiple sites for structures adjacent those malls. Further the method includes providing advertising on the structures. At least a portion of that advertising may be utilized to promote sales at the adjacent retail store or mall. Further the method may include marketing at least a portion of that advertising to another entity. For example, a vendor with products sold in the adjacent retail store or mall may desire to purchase the advertising space.

In accordance with additional aspects, the present method includes illuminating the advertising. This may be done in several ways. In one approach the method includes providing the advertising on banners and back lighting that advertising. In another, the method includes providing the advertising on banners made from an electroluminescent material. Such material, such as disclosed in, for example, U.S. Pat. No. 6,637,906 is self-illuminating. In yet another approach the method includes using a video display to provide the advertising. The video display may be, for example, a plasma monitor, a liquid crystal display and LED display or the like. Still further, the structure may include an electronic message board or a rotating sign assembly of a type described in, for example, U.S. Pat. No. 4,021,946 for displaying advertising.

In accordance with an additional aspect of the present invention, another entity may stage the emergency relief supplies from the structure. That entity may be any form of governmental or quasi governmental unit herein broadly referred to as a “governmental relief agency”. Alternatively, that entity may be a private relief agency of any form or type. Of course, the method may also include displaying public service information on the structure instead of advertising if and when desired.

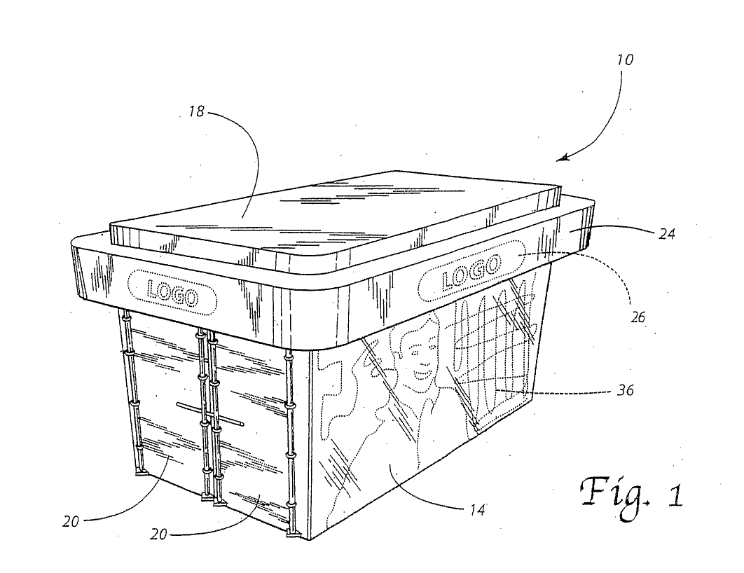

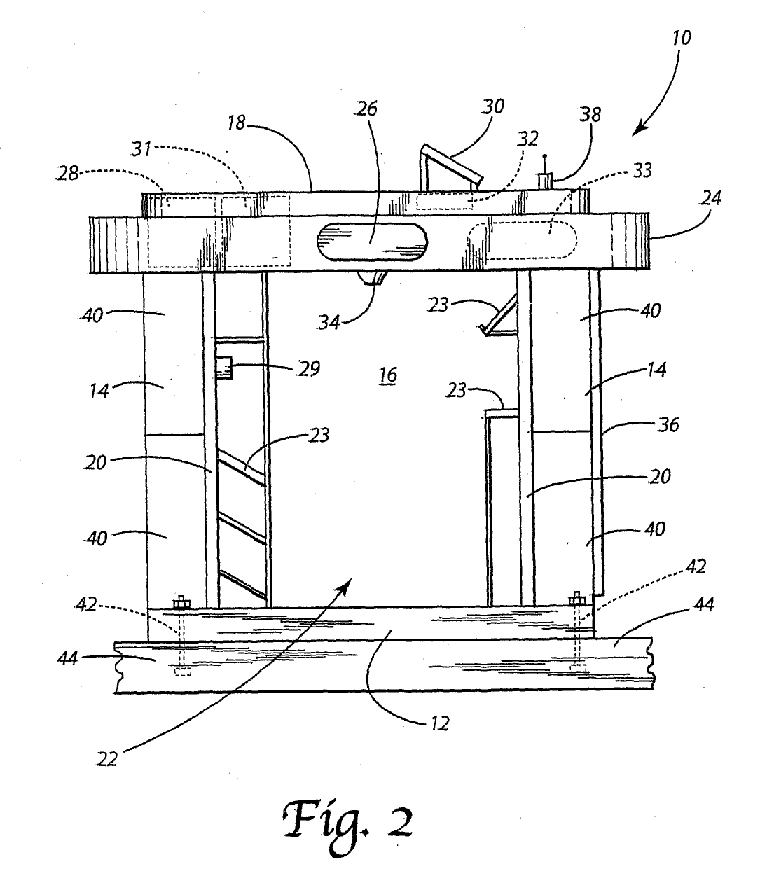

One possible construction of an emergency relief supply staging and/or storage structure 10 is illustrated in FIGS. 1-2. More specifically, the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That space 22 may be customized to meet any special needs for storing or staging emergency relief supplies such as water, food, baby formula, diapers, medicine, first aid, blankets, tents, bedding, communication equipment such as walkie talkies and satellite telephones, and the like.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to a user's specifications. The roof cap 24 may include advertising, trade dress or logo 26 if desired and/or as allowed by local regulations.

The structure 10 may also be equipped with various electrical and/or mechanical systems. For example, a refrigeration or other temperature control unit (ie. air conditioner, freezer, heater) 28 may be provided on the structure 10 in order to provide climate control of a portion or all of the space 22 within the storage structure. For example, a structure filled with water may be air conditioned or refrigerated to maximize the shelf life of the water. Another structure 10 may incorporate a freezer to allow ice to be stored in at least a portion of the structure.

In addition, the structure 10 may be equipped with a solar panel 30 and cooperating battery 32 to store energy for powering an internal lighting system 34 for illuminating the space 22 or illuminating advertising 36 on the side wall 14, end wall 16 or other exterior component of the structure 10. That advertising 36 may comprise a stretched banner material and it may be front lit or back lit as desired. In another possible embodiment, the banner may be made from a self-illuminating electroluminescent material such as a film or foil of a type known in the art and described in, for example, U.S. Pat. Nos. 5,767,451 and 6,637,906. Alternatively, the various electrical and mechanical components of the structure 10 may also derive their power from tapping into the lines of the local electrical utility company through an electrical box 29 and/or from connection with an electric generator 31. Such an electric generator 31 may be powered by natural gas from an underground gas line, by propane from a storage tank 33 or by fuel cell. While the storage tank 33 is shown as being provided on the structure 10 it could be located underground if desired.

Still further, the structure 10 may incorporate a radio transmitter 38 for the transmission of short range advertisements respecting products displayed in the advertising 36 appearing on the exterior surface of the structure 10. A particularly effective advertising combination is the use of an illuminated digital graphic advertising banner 36 in conjunction with local transmission radio advertising providing details of a particular product. This is particularly effective when advertising a product that is sold from the structure 10 or the place of business adjacent the structure. Of course, public service messages may also be broadcast in the event of a disaster or as desired.

The structure 10 may be constructed, for example, from modular building materials such as prefabricated panels 40 of the type shown and described in, for example, U.S. Pat. No. 6,279,287 to Meadows, U.S. Pat. No. 5,373,678 to Hesser and U.S. Pat. No. 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. Such structures may be specifically designed to withstand winds associated with Category 3, Category 4 or even Category 5 hurricanes as desired. The modular panels 40 also allow the structure 10 to be quickly and easily erected and subsequently removed in a minimal amount of time while producing a minimum of mess.

In yet another embodiment, the electronic display device 36 is carried on or in a cavity in the side wall 14, end wall 16 or door 20 of the structure 10. Any appropriate mounting brackets or fasteners (not shown) may be used to secure the display device 36 to the structure 10. The display device may comprise a liquid crystal display, a plasma monitor, an LED display or the like. Still further, the display device could be an electronic message board or a rotating sign assembly. Such a rotating sign assembly typically includes a series of three-sided display elements that periodically display three separate images or advertisements.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the door 20 may be provided in the side wall 16 rather than the end wall. Further, more than one set of doors 20 may be provided if desired. The structure could also include a tap connected to the public water supply. Still further, the structure could include a toilet and a shower connected to the public water supply and waste lines.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of public service, comprising:
providing at least one site for a structure from which emergency relief supplies are staged for benefitting a population in an event of disaster; and
promoting a business by providing said site.

2. The method of claim 1 including operating multiple retail stores and providing multiple sites for structures adjacent said multiple retail stores.

3. The method of claim 2, including providing advertising on said structures.

4. The method of claim 3, including using at least a portion of said advertising to promote sales at said retail store.

5. The method of claim 4, including marketing at least a portion of said advertising to another entity.

6. The method of claim 3, including illuminating said advertising.

7. The method of claim 3, including providing said advertising on banners and back lighting said advertising.

8. The method of claim 3, including providing said advertising on banners made from electroluminescent material and lighting said electroluminescent material.

9. The method of claim 4, including using a video display to provide said advertising.

10. The method of claim 9, including using a plasma monitor for said video display.

11. The method of claim 9, including using a liquid crystal display for said video display.

12. The method of claim 3, including using a rotating sign assembly to provide said advertising.

13. The method of claim 1, including allowing a governmental emergency relief agency to use said structure.

14. The method of claim 1, including allowing a private emergency relief agency to use said structure.

15. The method of claim 1, including displaying public service information on said structure.

16. The method of claim 1, including providing a tap in said structure connected to said public water supply.

17. The method of claim 1, including providing a toilet and a shower in said structure.

18. The method of claim 1, including providing a satellite telephone in said structures.

19. The method of claim 1, including providing an electric generator in said structure.

20. The method of claim 1, including operating multiple shopping malls and providing multiple sites for structures adjacent said multiple shopping malls.
